(19) United States
(12) Patent Application Publication
(10) Pub. No.: US 2004/0032798 A1
(43) Pub. Date: Feb. 19, 2004

(54) Watch with elastic band comprising a single strand

(76) Inventors: Herve Guillaume, Le Praz (FR); Robert Didier, Rue de Mionnaz (FR)

Correspondence Address: VAN TASSEL AND ASSOCIATES, POST OFFICE BOX 2928, BELLAIRE, TX, 77402-2928, US

(21) Appl. No.: 10/297,047

(22) PCT Filed: Jun. 18, 2001
(86) PCT No.: PCT/CH01/00377

(30) Foreign Application Priority Data
Jun. 23, 2000 (EP) 00 810554.6

(51) Int. Cl. A44C 5/00; G04B 37/00

(52) U.S. Cl. 368/281

(57) ABSTRACT

The invention concerns a timepiece comprising a watch (10) and a band (16) fixed to its case by solely one of its ends. The band, which constitutes a spring and is shaped to be wound around the wrist, comprises several spring wires (20) and a plurality of links (22, 24) threaded on the wires. To fix the ends of the wires on the case, are provided: integral with the watch case, two horns (14) each pierced with a pair of blind holes (26) and a passage which is perpendicular to the holes and intersects them in their lower part; integral with each end of the wires, a tube (30) inserted in each of the blind holes; and a key (32) inserted in said passage and passing through notches (34) provided at that site in each of the tubes.

The present invention concerns a wristwatch whose wristband has the peculiarity of forming a spring and comprising only a single strand.

More precisely, the wristband of such a watch is an elastic band one end of which is secured to the case, the other end of which is free and which has a bent shape so as to be wound around the wrist.

An embodiment of this type is disclosed in German Patent document No. DE 4 029 223. The wristband is then a simple steel strip forming a spring. This construction certainly provides an original aesthetic result but it is difficult to use when one desires a wristband with links, which considerably limits its interest.

The object of the present invention is to provide a watch whose single strand elastic wristband is formed of links and whose aesthetic appearance is in no way reduced because of its elastic properties.

More precisely, the invention concerns a timepiece comprising a watch formed of a case and a movement housed therein and a wristband secured to the case by only one of its ends, said wristband forming a spring and being shaped so as to be wound around the wrist. This timepiece is characterised:

in that the wristband includes several spring wires and a plurality of links threaded onto said wires, and

in that it includes means for securing the ends of the spring wires to the case.

Advantageously, the spring wires are made of steel and are four in number. In such case the securing means include:

secured to the watch case, two horns each pierced, on the one hand, with a pair of blind holes substantially parallel to the 12 o'clock-6 o'clock axis of the watch and, on the other hand, in their portion located on the back cover side, with a passage which is perpendicular to the blind holes and intersects them in their lower part;

secured to each end of the spring wires, a tube inserted into each of the said blind holes, and

a key bolt inserted into said passage and passing into notches arranged at that location in each of said tubes.

Moreover, according to an advantageous embodiment, the wristband includes, at its free end, an end link and, to fix this link to the ends of the spring wires, a plate pierced with grooves which are occupied by the wire ends and against the edge of which they are finally bent over, and a housing arranged in the end link for receiving the plate.

Other features of the invention will appear from the following description, made with reference to the annexed drawings, in which:

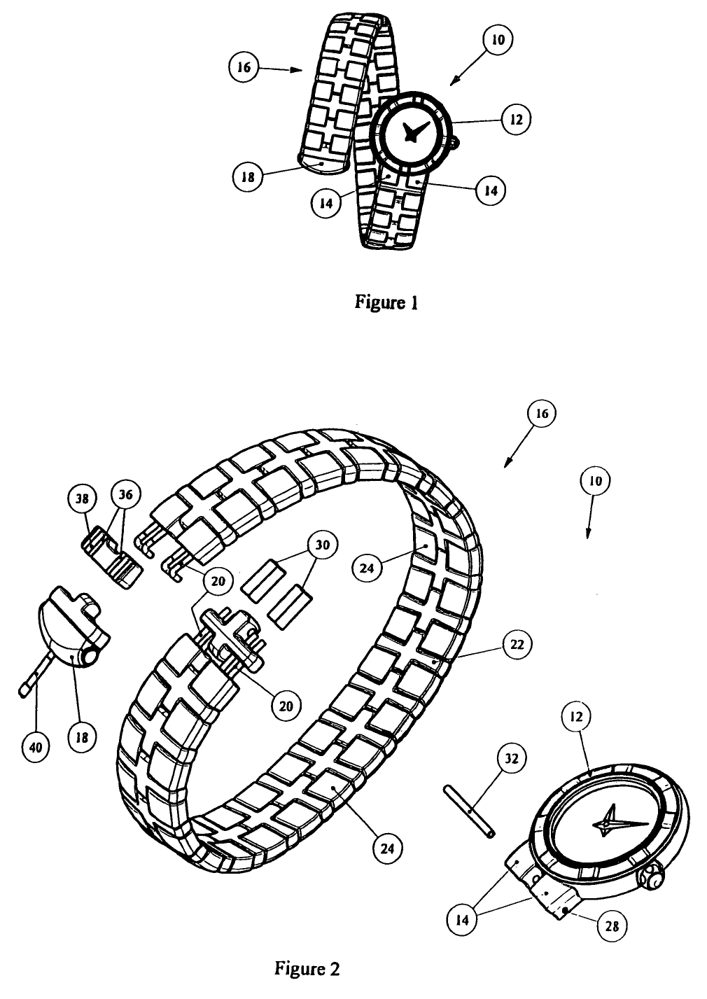

FIG. 1 shows the wristwatch according to the invention;

FIG. 2 is an exploded view of the timepiece;

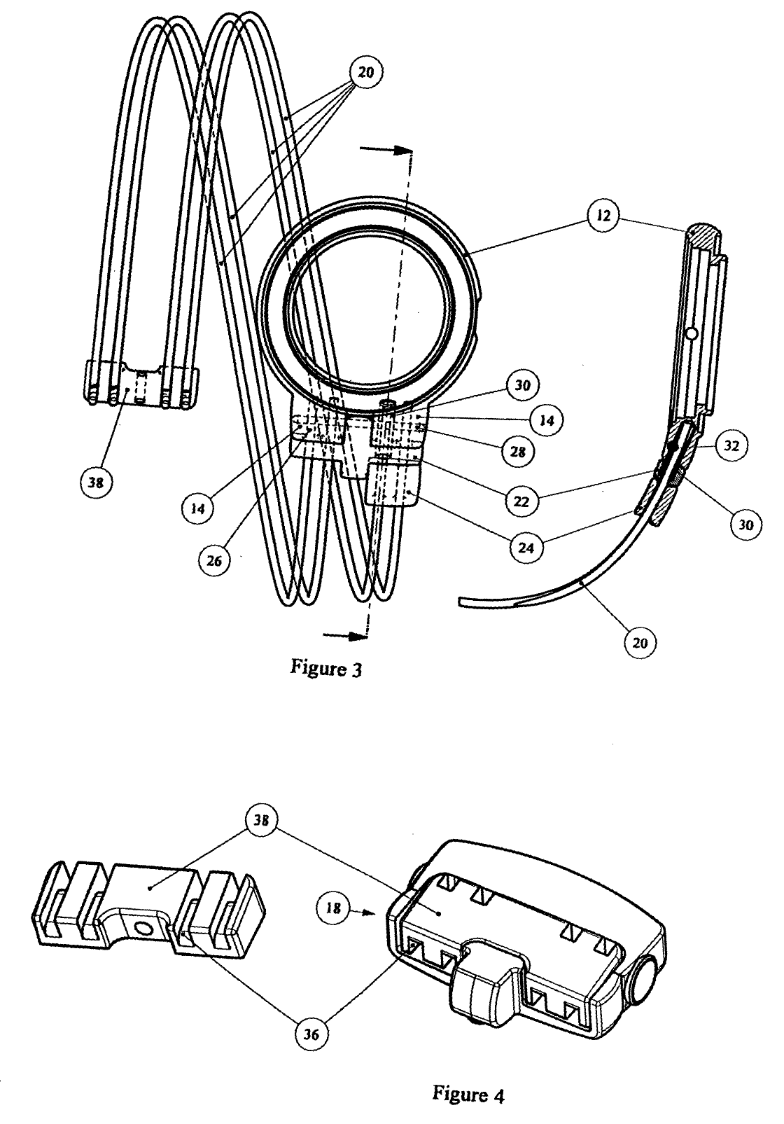

FIG. 3 is a partial view of the timepiece, without its links; and

FIG. 4 shows the details of the end link.

Reference will be made, first of all, to FIG. 1, which shows a watch 10 whose case 12 includes, only at 6 o'clock, two horns 14 on which is fixed the end of an elastic wristband with links in a single strand 16, the other end of it being provided with an end link 18.

More precisely, as is better shown by FIGS. 2 and 3, wristband 16 is formed of four steel spring wires 20, which are curved so as to be wound around the wrist and onto which a plurality of links are threaded, comprising, in a known manner, alternately cross-shaped links 22 and square links 24.

In order to secure wristband 16 to case 12, each horn 14 is pierced with a pair of cylindrical blind holes 26 parallel to the 12 o'clock-6 o'clock axis of the watch and arranged along a plane that drops with respect to case 12. Moreover, the two horns 14 are pierced, in their portion located on the back cover side, with a cylindrical passage 28, which is perpendicular to holes 26 and intersects them in their lower portion. The first link 22 is also pierced, at this location, with a passage aligned on passage 28.

The ends of the four spring wires 20, previously fitted with a tube 30, occupy holes 26. These tubes are secured to the wires either by being screwed on or by welding.

In order to anchor the ends of wires 20 in holes 26, a cylindrical key bolt 32 is inserted into passage 28 and passes into notches arranged at this location in each of tubes 30.

At their other end, as is better shown by FIGS. 3 and 4, the four wires 20 are positioned in grooves 36 arranged in a plate 38 against the edge of which they are finally bent over at approximately 90°, thus assuring the tightening and cohesion of the links onto wires 20. Plate 38 occupies the interior of the housing arranged in end link 18 that acts as its decorative cap. The cap is secured to plate 38 by a screw 40.

Thus, a watch is realised whose single strand wristband forming a spring, is provided with links that do not allow the spring itself to appear. Such a wristwatch has the originality of a single strand spring wristband, with an aesthetic appearance which is in no way reduced because of its elastic properties.

1. Timepiece comprising a watch (10) formed of a case (12) and a movement housed therein and a wristband (16) secured to the case by only one of its ends, said wristband forming a spring and being shaped to be wound around the wrist, characterised:
in that the wristband includes several spring wires (20) and a plurality of links (22, 24) threaded onto said wires, and
in that it includes means for securing the ends of the spring wires to the case.

2. Timepiece according to claim 1, wherein the spring wires (20) are made of steel.

3. Timepiece according to claim 1 or 2, wherein the spring wires (20) are four in number.

4. Timepiece according to claim 3, wherein said securing means include:
secured to the watch case, two horns (14) each pierced, on the one hand, with a pair of blind holes (26) substantially parallel to the 12 o'clock-6 o'clock axis of the watch and, on the other hand, in their portion located on the back cover side, with a passage (28) which is perpendicular to the blind holes and intersects them in their lower part;
secured to each end of the spring wires, a tube (30) inserted into each of the said blind holes, and
a key bolt (32) inserted into said passage and passing into notches (34) arranged at that location in each of said tubes.

5. Timepiece according to claim 4, wherein said tubes (26) are made secured to the ends of the wires by being screwed thereto.

6. Timepiece according to claim 4, wherein said tubes (26) are made secured to the ends of the wires by welding.

7. Timepiece according to claim 3, wherein the wristband includes, at its free end, an end link (18) and means for securing said link to the ends of the spring wires.

8. Timepiece according to claim 7, wherein said securing means include a plate (38) pierced with grooves (36) occupied by the ends of the wires and against the edge of which they are finally bent over, and a housing arranged in said end link to receive said plate.
